(19) United States
(12) Patent Application Publication
(10) Pub. No.: US 2019/0210250 A1
(43) Pub. Date: Jul. 11, 2019

(54) ISOTROPIZED READY-TO-USE PLASTIC PELLETS WITH HIGHLY ENTANGLED NANOFIBRILS AND METHOD OF PRODUCTION

(71) Applicants: Chul B. PARK, Etobicoke (CA); Ali RIZVI, Toronto (CA); Adel Ramezani KAKROODI, Toronto (CA); Chongxiang ZHAO, Toronto (CA)

(72) Inventors: Chul B. PARK, Etobicoke (CA); Ali RIZVI, Toronto (CA); Adel Ramezani KAKROODI, Toronto (CA); Chongxiang ZHAO, Toronto (CA)

(21) Appl. No.: 16/312,621

(22) PCT Filed: Sep. 12, 2017
(86) PCT No.: PCT/CA2017/051072

§ 371 Date: Dec. 21, 2018

Related U.S. Application Data
(60) Provisional application No. 62/393,208, filed on Sep. 12, 2016.

(51) Int. Cl. B29B 9/16; B29B 9/06; B29B 9/14; B29B 7/46; B29B 7/90

(52) U.S. Cl. CPC B29B 9/16; B29B 9/065; B29B 9/14; B29K 2105/124; B29B 7/90; B29K 2995/004; B29B 7/46

(57) ABSTRACT

Disclosed herein is a method for producing isotropized “ready-to-use” polymer pellets or granules that contain completely or substantially relaxed matrix molecules and entangled organic nanofibrils with long aspect ratios that will provide superior properties for the products without high cost. These pellets are cost-effectively produced using industrial-scale fiber spinning or melt-blowing/spun-bond equipment followed by an isotropizing pelletizer. These pellets enable one to mass-produce the micro-fibrillar or nanofibrillar composites with superior mechanical properties, because they are readily usable (“ready-to-use”) for industry-scale mass production systems with a very high throughput over 1000 kg/hr. The organic nanofibrils are well dispersed and entangled in the polymer matrix and have a long aspect ratio ranging hundreds to thousands, to tens of thousands. The nanofibrils are entangled with each other to have proper rheological properties for film or foam processing, and to have good mechanical properties of the final products.

### FIELD

The present disclosure relates to a process for the rapid and cost-effective production of in situ nanofibrillar all-polymer composite pellets, with relaxed matrix and highly entangled nanofibrils, using industrial-scale melt-spinning or melt-blown/spun-bond equipment. Particularly, the present process relates to i) production of in situ nanofibrillar composites using industrial-scale so melt-spinning or melt-blown/spun-bond equipment, followed by the continuous production of nanofibrillar composite pellets with relaxed matrices and highly entangled nanofibrils, and (ii) the product produced by the present method including in situ nanofibrillar pellets, with relaxed matrix and highly entangled nanofibrils, consisting of fully no-biodegradable, partially biodegradable, or fully biodegradable polymers. In addition, this disclosure relates to the production of in situ nanofibrillar composites and/or composite foams with superior mechanical properties.

### BACKGROUND

The present invention relates to the rapid and cost-effective production of in situ micro-fibrillar or nano-fibrillar composite pellets using industrial-scale fiber spinning or melt-blowing/spun-bond equipment. In addition, this invention relates to the production of in situ nano-fibrillar composites and composite foams with superior mechanical properties.

Thermoplastic composites, which are traditionally made through the incorporation of particulate or fibrous fillers into thermoplastics, are one of the most commonly used classes of materials. During the past decades, these composites have replaced traditional materials, such as metals, glass, and wood, in various applications including automotive, aerospace, packaging, and construction industries. Some of the major advantages of these materials include their ease of processing, light weight, low cost, and relatively high strength to weight ratio [1].

However, despite their many advantages, traditional polymeric composites suffer from a number of drawbacks which constrain their further market penetration. These drawbacks are mainly caused by the poor level of dispersion so of the fillers in the polymeric matrices. Poor dispersion of the fillers in composites results in agglomeration of fillers, stress concentration, and poor stress transfer from the polymeric matrix to the fillers. This, in turn, leads to severe losses in the mechanical, rheological, and physical properties of the composites [2,3]. Such losses are especially common in the case of composites with very small fillers such as nanoparticles and nano-fibers. Poor dispersion of nanoparticles and nano-fibers is usually caused by high interfacial tension between the polymer and the filler as well as the fact that the as-purchased nano-fillers already exist in the agglomerated form due to their very high specific surface areas.

One classic example is the case of cellulose nano-fibers (CNFs). CNFs, which are the main building units of plant cell walls, are obtained through a combination of chemical and mechanical treatment of wood and natural fibers. A combination of very high aspect ratio (ratio of length to diameter) and extremely high stiffness (nearly 13 GPa) makes these green nano-fibers a highly attractive choice for polymer composite production [4-6]. However, despite decades of research, it has been reported that the development of an economically viable technique for the production of CNF-based composites is extremely challenging. This is due to the fact that CNFs are highly hydrophilic due to the presence of a large number of polar hydroxyl groups on their surface [7]. As a result, good dispersion of CNFs can only be achieved in a small number of hydrophilic and water-soluble polymers.

During the past decade, the novel concept of in situ fibrillated composites has been considered as a highly attractive technique for the production of composites with nearly perfect dispersion of fibrous fillers. In this technique, a homogeneous blend of matrix (A) and dispersed phase (B) polymers (the melting point (Tₘ) of B must be at least 40° C., and preferably 60° C., higher than that of A) is first produced at T_{processing}>T_{mA} & T_{mB} using a conventional melt blending equipment. The blend is subsequently stretched, either in molten (hot stretching) or frozen (cold drawing) states, which transforms B from spherical domains into highly oriented fibrils with high aspect ratios. Then, the resulting fibrillated blend is further processed at T_{mA}<T_{processing}<T_{mB} to produce isotropic products with desired shapes. During this step, the matrix melts (and its molecules relax) and it is reshaped while the dispersed B fibrils maintain their fibrillar shapes. The presence of the highly stretched and well-dispersed B fibrils has been shown to significantly improve the mechanical, rheological, and physical properties of the matrix [8,9].

The unique procedure by which the in situ fibrillated composites are produced has several advantages over the traditional composite production methods. In these composites, the in situ formed fibrils are made by the elongation of already well-dispersed spherical B domains, making them perfectly dispersed. Naturally, a high level of dispersion of these fibrils increases their specific surface area, and this substantially benefits their properties. The in situ fibrillar composites also eliminate the environmental concerns and health hazards that are associated with the production and use of traditional nanofibers.

Several papers and patents have already been published regarding the nano-fibril technology. Fakirov et al. [10-13], Li et al. [14-15], and Macosko et al. [16-17] studied nano-fibrillation by stretching the blends. They successfully made nano-fibrila with diameter lower then ˜1 μm from the stretched phase in the blend. The product shows superior mechanical tensile strength and improved impact strength, compared to the unstretched raw blends.

For example, Fakirov et al. successfully strengthened the matrix polymer by stretching a blend and thereby forming nanofibrillated island phase particles [10]. Specifically, PP/PET blends are stretched [12], and thereby forming nanofibrillated PET phase particles. They stretched thick extrudates of the twin-screw compounded PP/PET blends by first dipping the extrudates in a cooling bath followed by stretching the reheated extrudates using two stretching rolls. The stretched extrudates were pelletized, and these pellets, as the base materials, were further processed in various processes. But the matrix material, i.e., PP, in the pellets was also stretched together with the microfibrillated PET. Furthermore, the PET microfibrils in the base materials of the pellets are not entangled, but linearly aligned in the stretched direction.

Another method to nano-fibrilize the island phase of a blend is to use a slit extrusion hot stretching-quenching process. Li et al. successfully strengthened the iPP materials with nanofibrillated PET by extruding an iPP/PET blend in a slit die followed by hot stretching and quenching [14-15]. The base materials used in the shaping process do not have enough nanofibril entanglements.

Another method to nano-fibrilize the island phase of a blend is to use a fiber-making spinning system. For example, Fakirov et al. [13] demonstrated the use of a melt-spinning system for stretching the twin-screw compounded PP/PET blends. The stretched PP fibers including nanofibrillated PET were weaved/knitted to form the base materials. These base materials were compression-molded to make PP/PET nanofibrillar composite products. These base materials have also aligned PET fibers and PP materials. Another example can be found in Macosko et al.'s “fiber-in-fiber” technology [16-17] that creates nanofibers in the stretched microfibers with a non-woven process, specifically with a melt-blown technology. The final products were the non-woven products with stronger mechanical properties. All these nanofibril-containing base polymer materials typically do not have enough entanglements of the nanofibers, but maintain the fibrous geometry to utilize the increased strength of the material in the fiber direction. The PP fibers are connected through local heating.

In spite of the above-mentioned fiber-making in situ fibrillation processes, success in the commercialization of nanofibrillated composite products has been limited by a few factors. First of all, the large volume of the fibers, either melt-spinned fibers or non-woven fibers, make it difficult to achieve a high throughput required for industrial production. Secondly, the fibers are not usually processable directly in a cost-effective continuous processing equipment such as an injection molding machine or an extruder. The present invention deals with this issue and offers an outstanding solution.

### SUMMARY

The present disclosure provides a process for the rapid and cost-effective production of in situ nanofibrillar all-polymer composite pellets, with relaxed matrix and highly entangled nanofibrils, using industrial-scale melt-spinning or melt-blown/spun-bond equipment. Particularly, this disclosure provides a process for production of in situ nanofibrillar composites using industrial-scale melt-spinning or melt-blown/spun-bond equipment, followed by the continuous production of nanofibrillar composite pellets with relaxed matrices and highly entangled nanofibrils, and (ii) the product: including in situ so nanofibrillar pellets, with relaxed matrix and highly entangled nanofibrils, consisting of fully no-biodegradable, partially biodegradable, or fully biodegradable polymers. In addition, this invention relates to the production of in situ nanofibrillar composites and/or composite foams with superior mechanical properties.

In an embodiment there is provided a method of production of in situ nanofibrillar all-polymer composite pellets, comprising the steps of:

a) melt extruding together a mixture at least two polymers A and B to produce a polymer blend of polymers A and B, in which T_{mB}>T_{mA},

b) feeding the polymer blend into a conventional fiber spinning apparatus to perform hot stretching or melt blowing to produce a composite material extrudate comprised of nanofibrils of polymer B contained within a matrix formed by polymer A, the nanofibrils having aspect ratios greater than about 100;

c) subjecting the composite material to an isotropization/relaxation step to induce relaxation of the matrix formed by polymer A; and

d) pelletizing the composite material extrudates to produce pellets, wherein due to the relaxation step, nanofibril of polymer B in the pellets are characterized by being isotropic and entangled.

The polymer B may be a semi-crystalline polymer with the melting temperature T_{mB} higher than the melting temperature T_{mA} of polymer A by at least 60° C.

The polymer B may be a semi-crystalline polymer with the melting temperature T_{mB} higher than the melting temperature T_{mA} of polymer A by at least 80° C.

The polymer A may be a semi-crystalline polymer with melting temperature T_{mA} lower than the T_{mB} of polymer B by at least 60° C.

The polymer A may be a semi-crystalline polymer with melting temperature T_{mA} lower than the T_{mB} of polymer B by at least 80° C.

The polymer A may be any one or combination of polyethylene (PE), polypropylene (PP), polyamide (PA), polycaprolactone (PCL), poly(lactic acid) (PLA) and polyvinyl alcohol (PVOH).

The polymer B may be any one or combination of polyethylene terephthalate (PET), polybutylene terephthalate (PBT), poly(lactic acid) (PLA), polyamide (PA), polyether ether ketone (PEEK) and polymethylpentene (TPX).

The final pellets may be produced to have an average diameter of less than about 400 nm, or produced to have an average diameter of less than about 300 nm, or they may be produced to have an average diameter of less than about 200 nm, or they may be produced to have an average diameter of less than about 100 nm, or they may be produced to have an average diameter of less than about 50 nm.

The nanofibers may be produced to have an aspect ratio of at least about 1000, or they may be produced to have an aspect ratio of at least about 10,000.

The polymer A and polymer B may be selected to have an interactive solubility parameter (.chi.) of greater than about 0, or they may be selected to have an interactive solubility parameter (.chi.) of greater than about 1.

The method further comprises treating the composite fiber with a solvent that dissolves the matrix formed by polymer A from the composite material and that does not dissolve the nanofibers formed by polymer B.

The polymer A and polymer B may be present in the blend at a mass ratio of between about 95:5 and about 50:50, or polymer A and polymer B may be present in the blend at a mass ratio of between about 80:20 and about 50:50.

The blend may further comprise one or more additives, these additives being any one or combination of anti-oxidants, anti-stats, blooming agents, colorants, flame retardants, lubricants, peroxides, stabilizers, and wetting agents.

The step of producing the blend may be carried out at a processing temperature in a range from about 150° C. to about 400° C.

The steps of production of the pellets may be controlled to give mass output of pellets is in a range from about 5 kg/h to about 1000 kg/h, or in a range from about 5 kg/h to about 100 kg/h.

The mixture of at least two polymers A and B may further comprise a coupling agent selected to improve a morphology of the nanofibrils. This coupling agent may be a grafted/block polymer. The coupling agent may be any one or combination of maleic anhydride grafted polypropylene (MA-g-PP), maleic anhydride grafted polyethylene (MA-g-PE) and thermoplastic polyolefin.

The mixture of at least two polymers A and B may further comprise one or more kinds of chemical agents selected to tune a molecular weight of the polymer B to match the viscosity of polymer A. The additive may be selected, and present in the mixture, to give a viscosity ratio of polymer A to polymer B of about 1:1.

The step c) of subjecting the composite material to a so isotropization/relaxation step is achieved by any one of extrusion, injection and compression/steam molding.

A pellet produced by the present method may be used in injection molding, extrusion, compression molding to make polymer products.

A pellet produced by the present method may be for use in injection molding foaming, extrusion foaming, bead foaming, steam chest molding.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1(a) is a scanning electron microscope (SEM) image of polyethylene terephthalate (PET) nano-fibrils extracted from the stretched polypropylene-polyethylene terephthalate (PP-PET) nano-fibril composite without any coupling agent after the dissolution of the polypropylene (PP) matrix with xylene. The small residues on the PET fibrils were the precipitated PP that was dissolved in the xylene, which remained on the surface of the PET. We tried to wash the PET fibers with fresh xylene, but we could not remove the contaminated xylene (that had dissolved PP) completely.

FIG. 1(b) The SEM image of PET nano-fibrils extracted from the stretched PP/coupling-agent/PET nano-fibril composite.

FIG. 2 is an SEM image of: (a) PP/5 wt % amorphous polyethylene terephthalate (APET) nano-fibril composite, (b) PP/5 wt % crystallizable-polyethylene terephthalate (CPET) nano-fibril composite.

FIG. 3 shows an exemplary overall system for making isotropized “ready-to-use” pellets or granules with highly entangled nano-fibrils by using traditional melt spinning technology and associated system.

FIG. 4 shows an exemplary overall system for making isotropized “ready-to-use” pellets or granules with highly entangled nano-fibrils by using traditional melt-blown or spunbond technology and system.

FIG. 5 shows an exemplary isotropization setup using a counter-rotating twin-screw extruder followed by a solid-state pelletizing process.

FIG. 6 shows an exemplary isotropization setup with a counter-rotating twin-screw extrusion followed by an underwater pelletizing process.

FIG. 7 shows an exemplary isotropization setup for a low-shear continuous kneader followed by a solid-state pelletizing process.

FIG. 8 shows an exemplary isotropization setup for a low-shear continuous kneader followed by the underwater pelletizing process.

FIG. 9 shows an exemplary isotropization setup that uses a single-screw extruder followed by the solid-state pelletizing process.

FIG. 10 shows an exemplary isotropization setup for a single-screw extrusion followed by an underwater pelletizing process.

FIG. 11 shows: (a) a schematic isotropization of the spinning fiber, and (b) entangled polyethylene terephthalate (PET) nano-fibril after isotropization.

FIG. 12 shows non-limiting examples of the use of the entangled nano-so pellets produced by the method disclosed herein in various cost-effective processes.

### DETAILED DESCRIPTION

Various embodiments and aspects of the disclosure will be described with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

The present disclosures discloses a method for producing isotropized “ready-to-use” polymer pellets or granules that contain completely or substantially relaxed matrix molecules and entangled organic nanofibrils with long aspect ratios that will provide superior properties for the products without high cost. These pellets are cost-effectively produced using industrial-scale fiber spinning or melt-blowing/spun-bond equipment followed by an isotropizing pelletizer. These pellets will enable one to mass-produce the micro-fibrillar or nanofibrillar composites with superior mechanical properties, because they are readily usable (“ready-to-use”) for industry-scale mass production systems with a very high throughput over 1000 kg/hr. The organic nanofibrils are well dispersed and entangled in the polymer matrix and have a long aspect ratio ranging hundreds to thousands, to tens of thousands. The nanofibrils are entangled with each other to have proper rheological properties for film or foam processing, and to have good mechanical properties of the final products.

The nanofibrils are typically made out of a semi-crystalline polymer with the melting temperature higher than the melting temperature of the polymer matrix by at least 60° C., preferably 80° C. or higher, so that the nanofibrils do not shrink when the matrix materials are melt-processed in a regular processing equipment for completing the composite shaping. The polymer matrix can be a semi-crystalline polymer with a much lower melting temperature (by at least 60° C., preferably 80° C. or more), so that the matrix material can be melt-processed in a regular processing equipment for shaping without allowing the shrinkage of the nanofibrils. The polymer matrix can also be an amorphous polymer as long as its melt-processing temperature is lower than the melting temperature of the nanofibrils at least by 30° C.

The isotropization of the stretched micro-sized fiber blends to completely or substantially relax the matrix material and without shrinking the nanofibers is one of the central issues in the present invention. In order to manufacture the isotropized polymer pellets or granules that contain completely or substantially relaxed matrix molecules and highly entangled nanofibrils, we need to selectively melt the stretched matrix material only during the isotropizing palletization process. Because of the fact that the stretched nanofibrils will shrink when exposed to a high temperature near or above the melting temperature of the stretched fibers, the isotropization process is conducted in a low shear heating system to avoid any high temperature surge locally. A counter-rotating twin screw extruder, a continuous kneader, or a single screw extruder can be used for this purpose. Finally, the desired shape of the pellets is obtained, to be used in any continuous processing equipment for mass production.

During the isotropization process, the matrix molecules shrink and, therefore, the stretched micro-sized fibers shrink. But the stretched nanofibrils do not shrink but recoil during the shrinkage of the matrix chains. Since the temperature is below the melting temperature of the nanofibrils, the nanofibrils will be further crystallized. There may be slight shrinkage of the amorphous sections of the nanofibrils, but this isotropization process provides a good annealing effect for the nanofibrils to increase their thermal and dimensional stability in the final shaping process through an increased crystallinity. The materials are subject to a weak shear field the isotropization equipment and the recoiled nanofibrils are tumbled and eventually entangled each other. So the final pellet products will have very desirable characteristics of high entanglements of the nanofibrils and high thermal and dimensional stability.

The improved in situ fibrillation technology disclosed herein, namely, relaxation and pelletizing of the matrix material in temperatures lower than the melting temperature of reinforcement, after hot stretching using a commercial fiber spinning equipment or melt blowing followed by palletization, has been designed and experimentally proven to alleviate the drawbacks associated with the processing and characteristics of the in situ fibrillar composites. Further, the production of the nanofibrillar structure is shown to significantly improve the characteristics of biodegradable and non-biodegradable polymeric foams with various matrices.

In this disclosure, the following methodology has been utilized for the cost-effective and rapid production of isotropized “ready-to-use” polymer pellets or granules that contain completely or substantially relaxed matrix molecules and entangled organic nanofibrils with long aspect ratios.

### 1) Dispersion of the Nanofibril Material in the Polymer Matrix Using a Twin Screw Compounder.

First, vigorous mixing of blends of different immiscible polymer systems (with T_{mB}>T_{mA}) such as polypropylene (PP)/amorphous-polyethylene terephthalate (APET), PP/crystallizable-PET (CPET), metallocene polyethylene (mPE)/PP, PP/polybutylene terephthalate (PBT), PP/polymethylpentene (TPX), poly(lactic acid) (PLA)/polyamide 6 (PA6), polycaprolactone (PCL)/PLA, PA6/polyether ether ketone (PEEK), PA6/polyamide 6T (PA6T), ABS/PA6T, PC/PA6T, PC/ABS/PA6T, etc. is performed using a co-rotating twin-screw extruder.

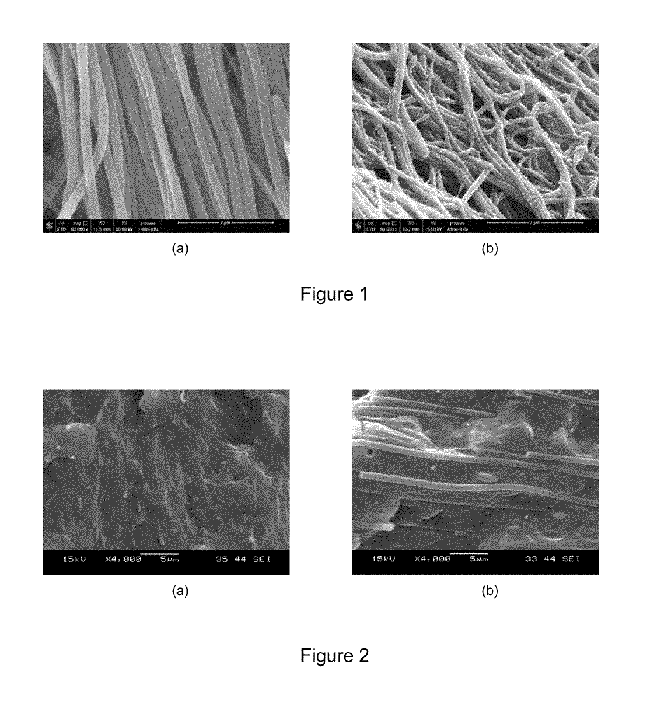

A coupling agent can also be added into the system to improve the morphology of the fibrils. The coupling agent normally is a grafted/block polymer. Thus, a coupling agent can be represented as A-B, where the functional so chemical group B is grafted onto polymer A. Normally a functional chemical group has high affinity to the reinforcement phase. Thus, by using a coupling agent, the dispersion of the reinforcement phase is improved in the compounding stage. In the spinning stage, the coupling agent also has a positive effect. Since a coupling agent significantly improves the bonding between the reinforcement and the matrix, the extensional force will be effectively transferred from the matrix to the reinforcement. Consequently, the fibril's aspect ratio increases and the fibril diameter decreases. All of these factors result in a finer fibril size, and improve the mechanical properties of the final product. Examples of typical coupling agents for the PP/Pet system include maleic anhydride grafted polypropylene (MA-g-PP), maleic anhydride grafted polyethylene (MA-g-PE), ethylene-glycidyl methacrylate (E-GMA), thermoplastic polyolefin, and so forth. FIG. 1 shows that the use of a coupling agent will decrease the diameter of the nanofibrillated phase B.

FIG. 1(a) is an SEM image of PET nano-fibrils extracted from the stretched PP-PET nano-fibril composite without any coupling agent after the dissolution of the PP matrix with xylene. The small residues on the PET fibrils were the precipitated PP that was dissolved in the xylene, which remained on the surface of the PET. The inventors tried to wash the PET fibers with fresh xylene, but could not remove the contaminated xylene (that had dissolved PP) completely. FIG. 1(b) The SEM image of PET nano-fibrils extracted from the stretched PP/coupling-agent/PET nano-fibril composite.

The second-phase material to be nanofibrillated can have different crystallization kinetics to control the viscosity for facilitating the processing, and to enhance the mechanical properties and the thermal and dimensional stability of so the final products. For example, APET or CPET can be used for the PET material to be fibrillated. APET is typically a homopolymer PET with a slow crystallization kinetics but APET can also be copolymerized to further decrease the crystallization rate. CPET has a crystal-nucleating agent to enhance the crystallization kinetics. The viscosity of APET increases slowly during cooling because of the low crystallization rate and, therefore, it takes a long time to solidify the APET while the APET is getting stretched. So, it has a larger processing (temperature) window during cooling, resulting in a finer fibril morphology. However, due to its slow crystallization kinetics, the crystallinity may be low and, consequently, it may have low thermal and dimensional stability. The fine fibril morphology achieved may shrink during the isotropization or even in the further shaping (final) processing. On the other hand, CPET has a very high crystallization rate. The viscosity would increase quickly as the material cools down because of the fast crystallization. So, the CPET fibrils get solidified quickly before they become stretched enough and, therefore, it is difficult to achieve a small fibril diameter of CPET. But in contrast, the thermal and dimensional stability of CPET is better with less shrinkage in isotropization and final processing because of the higher crystallinity. FIG. 2 shows the typical sizes of APET and CPET fibrils in the PP matrix developed during fiber spinning. APET has a smaller diameter, compared to CPET.

The concentration of the dispersed phase B must be low enough to prevent the formation of a co-continuous phase morphology. But, with the use of a coupling agent, the reinforcement content can be increased without an increase in the second-phase size. The processing temperature for this step should be preferably at least 10-20° C. higher than T_{mB}.

The MFI of polymer B can be properly chosen or some chemical additives can be added to tune the viscosity of polymer B. If the viscosity of polymer B is too high compared to that of polymer A, the dispersed phase B would not deform when applying deformation on polymer A during stretching or melt blowing. It is well-known that the optimal viscosity ratio of polymer A to polymer B to minimize the size of the dispersed B, would be about 1:1.

### 2) Nanofibrillation Using a Spinning System.

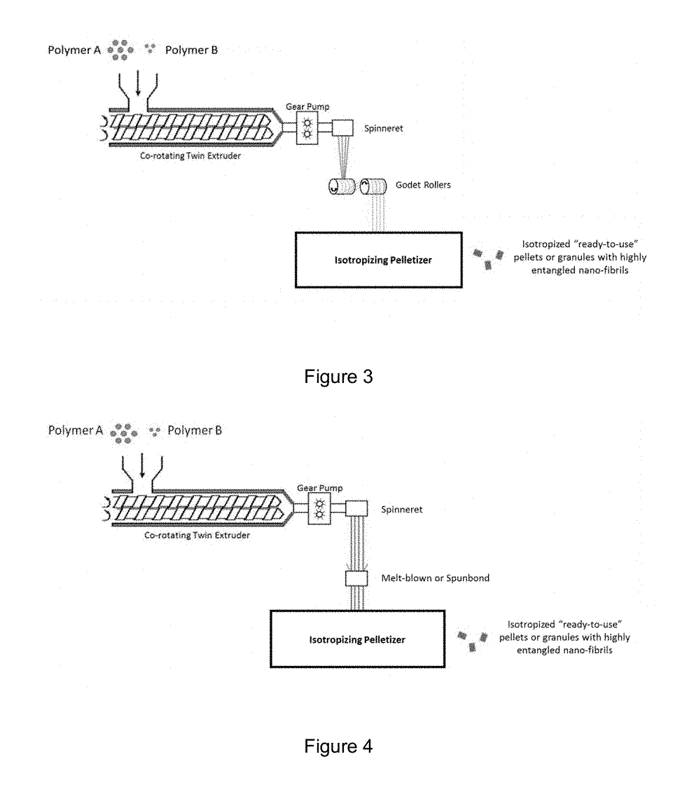

The compounded blends are subsequently fed into a conventional melt-spinning (FIG. 3) or melt-blown/spunbond equipment (FIG. 4) to effectively apply a uniaxial extensional flow and transform their dispersed spherical domains into stretched nanofibrils. In a typical run, the compounded blends are fed into the hopper of the fiber spinning system which typically uses a single screw extruder. Alternatively, the twin-screw compounder can replace the single screw extruder in the spinning system, to simply the compounding and spinning facilities. The temperature of the extruder barrel is maintained above the melting points of both the matrix and the dispersed phase (T_{processing}>T_{mA} and T_{mB}). A gear pump is attached after the extruder to regulate the melt flow before the melt reaches the spinneret. The gear pump speed is adjusted to suit the feeding rate and the screw speed of the single screw extruder. The spinneret comprises numerous capillary dies.

As the numerous extruded filaments exit the spinneret, they pass through a cross-flow ventilation system which cools the extruded filaments before they come in contact with the draw rolls, known as the godets. The rotational motion so of the godet draws the extruded filaments. By controlling the rotational speed of the godets, the extrudates' draw ratio can be controlled. Or alternatively, the numerous extruded filaments coming out of the spinneret are blown by high-pressure air in a melt-blown/spunbond system. By controlling the air pressure of the melt-blown/spunblond system, the draw ratio of the extruded filaments can be controlled. The air is heated to a high temperature that can blow the extruded filaments upon exiting the spinneret, in the melt-blown system. In the spunbond system, a cold air stream is used to stretch the extruded filaments. These melt-blown and spunbond systems a well-known art in the fiber spinning industry.

Since an industry-scale fiber-spinning equipment can stretch a large amount of polymer melt, high production rates can be obtained. In addition, using fiber spinning equipment, it is possible to achieve very high stretching capacities which lead to the production of fibrillated blends with extremely fine dispersed nanofibrils. Such nanofibrils have extremely high specific surface areas (that is, the surface area of the fibrils per unit of their weight).

It is also possible to combine the melt blending (twin screw extrusion) and the fiber spinning processes via replacement of the single screw extruder in the fiber spinning system with a twin screw extruder. Using this technique, the system becomes simplified and the compounded blends can be directly fed to the fiber spinning machine.

3) Isotropization of the Stretched Fibrils and Production of “Ready-to-Use” Pellets with Highly Entangled Nanofibrils and a Relaxed Polymer Matrix.

The isotropized “ready-to-use” pellets that are appropriate for industry-scale mass production with high throughputs can be cost-effectively manufactured using an isotropizing pelletizer. Isotropization of the produced micro-sized fibers is subsequently performed by remelting the continuous fibers or non-woven products inside continuous extrusion processing at a temperature much below the melting temperature of the nanofibrils. The nanofibrils are effectively entangled and further crystallized during this process. Finally, the desirable pellets are made either by a solid-state pelletizer or an underwater pelletizer.

The isotropization is critical in producing highly entangled nano-fibril pellets and stabilizing the morphology of those nano-fibrils in downward processing. Generally, the nano-fibrils which are produced from the melt spinning or the melt-blown/spunbond processes are highly oriented and almost parallel to each other in the matrix along the processing direction. However, nano-fibrils recoil in a melted matrix to a certain degree when they are subject to post processes such as compression molding.

Two major improvements are achieved through using our low shear isotropization technology. First, highly entangled nano-fibrils are obtained. When the fiber material is fed into the low shear isotropization setup, in contrast to the matrix which melts, relaxes and consequently shrinks, the nano-fibrils do not shrink due to their high melting temperature. As a result, the shrinking matrix leads the nano-fibril to recoil. With the help of low shear generated from the isotropization system, those recoiled nano-fibrils further entangle with each other and form a physical network structure. Second, the isotropization system will help nano-fibrils to have a high thermal and dimensional stability in downward processing (to keep the nano-fibril morphology). The nano-fibrils obtained from the melt spinning or melt-blown/spunbond do not completely crystallize due to the fast cooling rate. These nano-fibrils with low crystallization contents tend to shrink in the later shaping processes (especially with those high shear processing conditions). However, by implementing the isotropization system, the nano-fibrils can further crystallize as they are subject to a low shear plasticization, which can be considered as an annealing stage for the nano-fibrils. Thus, the isotropization technology the nano-fibrils to fully crystallize (although with limited deformation due to the neighboring crystals) which increases their thermal and dimensional stability in downward processing.

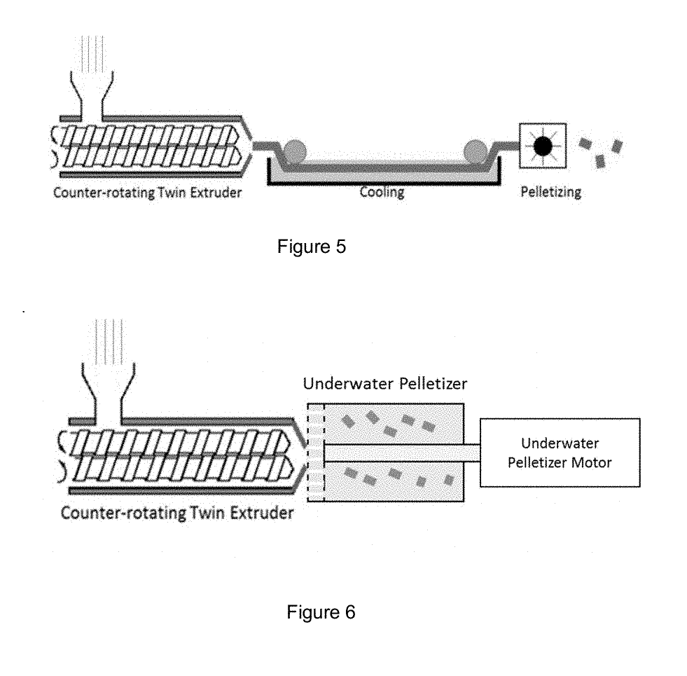

FIG. 5 shows an exemplary isotropization setup using a counter-rotating twin-screw extruder followed by a solid-state pelletizing process. This type of extruder is used to relax the matrix and to anneal the nano-fibril material since a low shear rate is applied. Counter-rotation twin-screw extrusion is well-known and is frequently practiced in the PVC processing industry. Most PVC extruders are the counter-rotating twin-screw type, which have a lower shear rate [18]. This is because a high shear rate will locally overheat the material and will thus generate a high temperature. The high temperature will decompose the PVC and erode the equipment.

In the method disclosed herein, the low shear generated by the counter-rotation twin-screw extruder will produce extrudate with highly entangled nano-fibrils while the annealing will further crystallize the nanofibrils to increase their thermal and dimensional stability in the next shaping process. In this setup, the stretched fiber material is fed from the twin-screw extrusion hopper. The barrel temperature can be set at only about 20° C. higher than the matrix polymer's melting temperature. The counter-rotation twin-screw speed can be set at a low value to avoid generating excessive shear. Then, the matrix is melted so that it is, relaxed inside the barrel before it is pushed out through a die. The extrudate is then drawn through a water tank, cooled, and then cut via a solid-state pelletizing process. The pellets may have some orientation in the flow direction if the drawing speed is higher than the extrudate speed at the die. But the degree of orientation is not as high as the stretched and cut pellets observed in Ref [12].

FIG. 6 shows an exemplary isotropization setup with a counter-rotating twin-screw extrudsion followed by an underwater pelletizing process. This is exactly the same as FIG. 5 except for the pelletizing step. The underwater pelletizer is more attractive because the extrudate is cut at a high temperature and the cut pellets are relaxed in hot water to remove all the orientation of the matrix polymer molecules.

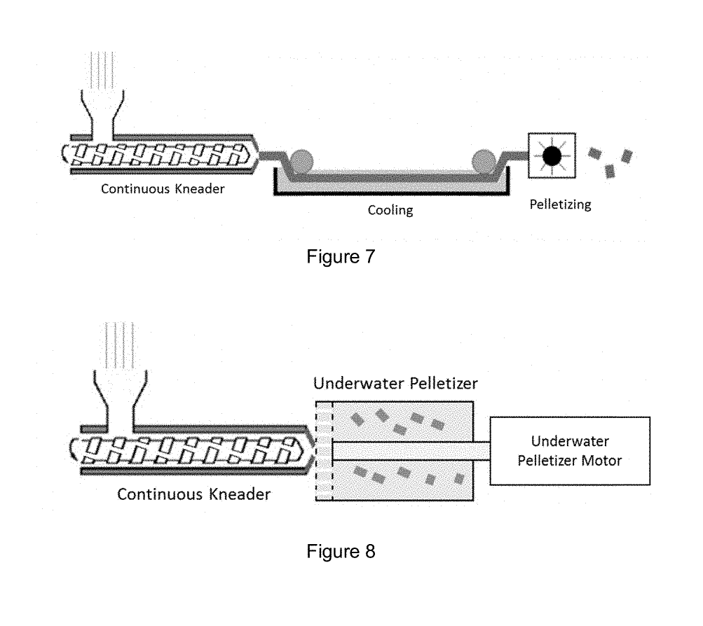

FIG. 7 shows an exemplary istropization setup that uses a low-shear continuous kneader, which is followed by a solid-state pelletizing process. A kneader is also a well-known equipment used for blending and compounding heat-sensitive materials to avoid overheating. Because of the low shear action of the continuous kneaders, this system is suitable for the isotropization of the stretched fibers containing the nanofibrils. In this setup, the stretched fiber material is fed into the kneader's hopper. The barrel temperature can be set at only about 20° C. higher than the matrix polymer's melting temperature as in the case of the counter-rotating twin screw extruder. The rotational speed of the kneader is set at a low value to avoid generating excessive shear heat. Then the matrix is melted into a relaxed state within the barrel before it is pushed out through a die. The extrudate is then drawn through a water tank, cooled, and then cut as part of the solid-state pelletizing process as described earlier.

FIG. 8 shows an exemplary isotropization setup for a low-shear continuous kneader followed by the underwater pelletizing process. This is exactly the same as FIG. 7 except for the pelletizing step. Instead of using the solid state pelletizing, underwater pelletizing can be utilized to have more relaxed polymer matrix molecules.

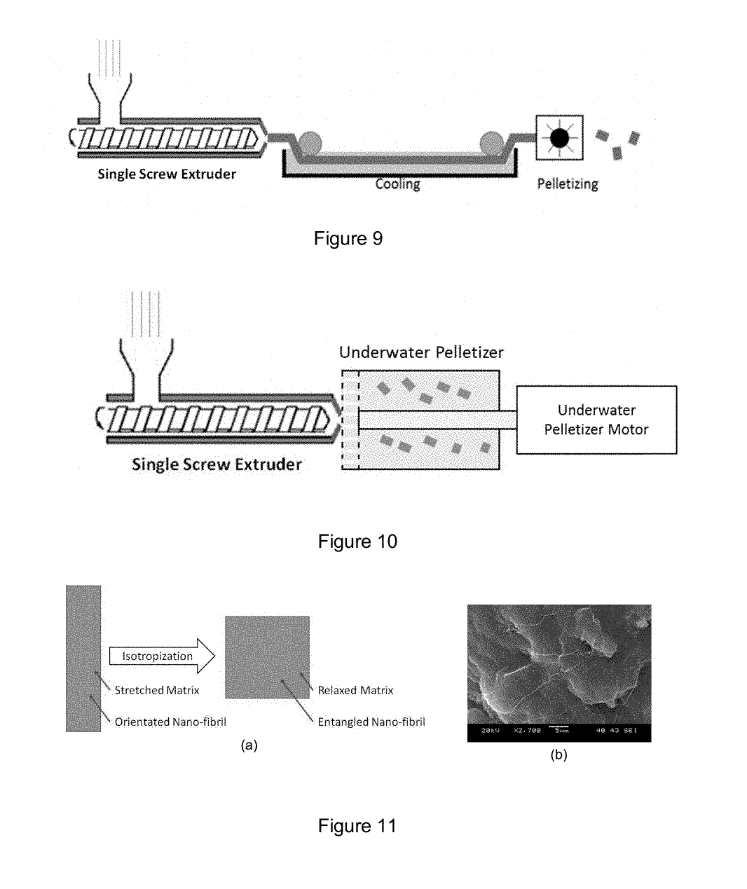

FIG. 9 shows an exemplary isotropization setup that uses a single-screw extruder followed by the solid-state pelletizing process. This too is a good choice with a screw's low rotational speed to avoid any local shear heating. The matrix polymer is melted, relaxed inside the barrel, and pelletized using solid state pelletizing. FIG. 10 shows an exemplary isotropization setup for a single-screw extrusion followed by an underwater pelletizing process which will be well known to those skilled in the art.

Generally speaking, isotropization requires a low shear system and has an annealing effect on the stretched nanofibrils to further increase the crystallinity while entangling the nanofibrils (FIG. 11). The low shear is maintained for several reasons. First, it prevents any possible local overheating, which will lead to nano-fibrillar shrinkage. Second, it induces a highly entangled nano-fibrillar structure.

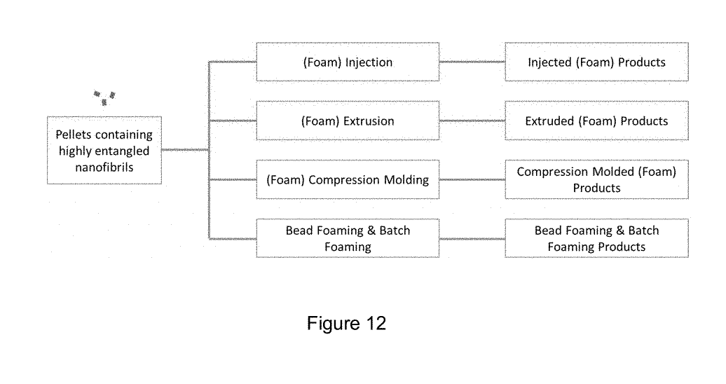

The produced isotropized pellets having entangled nanofibrils and relaxed matrix material, ready-to-use for mass production over 500 kg/hr, can be used for any conventional processes such as injection molding, extrusion, compression molding, rotomolding, bead foaming, etc. as summarized in FIG. 12. Because of the presence of the nanofibrils, the melt strength is typically increased and the foaming ability of the resin is enhanced dramatically [19-20]. So, these resins can be effectively used for the foam and film applications because of the outstanding rheological properties.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

1. Breuer O., Sundararaj U., Polymer Composites, Vol, 25, 630 (2004)
2. Mapkar J. A., Belashi A., Berhan L. M., Coleman M. R., Composites Science and Technology, Vol, 75, 159 (2013)
3. Kabir M. M., Wang H., Lau K. T., Cardona F., Composites Part B: Engineering, Vol, 43, 159 (2012)
4. Ramezani Kakroodi A., Cheng S., Sain M., Asiri A., Journal of Nanomaterials, Vol, 2014, 139 (2014)
5. Jonoobi M., Harun J., Mathew A. P., Oksman K., Composites Science and Technology, Vol, 70, 1742 (2010)
6. Ding W., Kuboki T., Wong A., Park C. B., Sain M., RSC Advances, Vol. 5, 91544 (2015)
7. Wang T., Drzal L. T., ACS Applied Materials and Interfaces, 4, 7 (2012)
8. Yi X., Xu L., Wang YL., Zhong G. J., Ji X., Li Z. M., European Polymer Journal, Vol, 46, 719 (2010)
9. Rizvi A., Park C. B., Polymer, Vol. 55, 21131 (2014)
10. Evstatiev M., Fakirov S., Microfibrillar reinforcement of polymer blends. Polymer, Vol. 33, 877 (1992)
11. Evstatiev M., Fakirov S., Bechtold G., Friedrich K., Advances in Polymer

Technology, Vol. 19, 249 (2000)
12. Fakirov S., Friedricha K., Evstatievb M., Evstatieva O., Ishiic M., Harrassa M., Composites Science and Technology, Vol. 65, 107 (2005)
13. Fakirov S., Bhattacharyya D., Shields R. J., “Nanofibril reinforced composites from polymer blends”, Colloids and Surfaces, Vol. 313-314, 2 (2008)
14. Li Z. M., Yang W., Li L. B., Xie B. H., Huang R., Yang M. B., Journal of Polymer Science: Part B: Polymer Physics, Vol: 42, 374 (2004)
15. Li Z. M., Li L. B., Shen K. Z., Yang W., Huang R., Yang M. B., Macromolecular Rapid Communications, Vol. 25, 553 (2004).
16. Jeung S., Tan D., Zuo F., Bates F., Macosko C., Wang Z., Non-Woven Fibers-in-Fibers from Melt-Blown Polymer Blends, PCT/U.S. Pat. No. 9,211,688 B1 (2015)
17. Zuo F., Tan D. H., Wang Z., Jeung S., Macosko C. W., Bates F. S., ACS Macro Letters, Vol. 2, 301 (2013)
18. Shah A., Gupta M., “Comparison of the Flow in Co-Rotating and Counter-Rotating Twin-Screw Extruders”, SPE ANTEC, Technical Papers, 443 (2004)
19. Rizvi A., Park C. B., Favis B. D., “Tuning Viscoelastic and Crystallization Properties of Poly(propylene-co-ethylene) Random Copolymer Using High Aspect Ratio Polyethylene Terephthalate Fibrils”, Polymer, Vol. 68, 83 (2015)
20. Rizvi A., Andalib Z. K. M., Park C. B., “Fiber-Spun Polypropylene/Polyethylene Terephthalate Microfibrillar Composites with Enhanced Tensile and Rheological Properties and Foaming Ability”, Polymer, Vol. 110, 139 (2017)

What is claimed is:

1. A method of production of in situ nanofibrillar all-polymer composite pellets, comprising the steps of:
a) melt extruding of a mixture of at least two polymers A and B to produce a polymer blend of polymers A and B, wherein the melting temperature of polymer B, T_{mB}, is larger than the melting temperature of polymer A, T_{mA};
b) feeding the polymer blend into a fiber spinning apparatus to perform hot stretching or melt blowing to produce a composite material extrudate comprised of a nanofibrils of polymer B contained within a matrix formed by polymer A, wherein the nanofibrils of polymer B having aspect ratios greater than about 100;
c) subjecting the composite material to an isotropization/relaxation step to induce relaxation of the matrix formed by polymer A; and
d) pelletizing the composite material extrudates to produce pellets having an average pellet diameter, wherein the nanofibril of polymer B in the pellets are characterized by being isotropic and entangled due to a relaxation process.

2. The method according to claim 1, wherein polymer B is a semi-crystalline polymer with the melting temperature T_{mB} higher than the melting temperature T_{mA} by at least 60° C. or at least 80° C.

3. (canceled)

4. The method according to claim 1, wherein polymer A is a semi-crystalline polymer with melting temperature T_{mA} lower than the T_{mB} of polymer B by at least 60° C. or at least 80° C.

5. (canceled)

6. The method according to any one of claim 1, wherein polymer A is any one or combination of polyethylene (PE), polypropylene (PP), polyamide (PA), polycaprolactone (PCL), poly(lactic acid) (PLA) and polyvinyl alcohol (PVOH).

7. The method according to any one of claim 1, wherein polymer B is any one or combination of polyethylene terephthalate (PET), polybutylene terephthalate (PBT), poly(lactic acid) (PLA), polyamide (PA), polyether ether ketone (PEEK) and polymethylpentene (TPX).

8. The method according to any one of claim 1, wherein the average pellet diameter is less than about 400 nm or 300 nm or 200 nm or 100 nm or 50 nm.

9. (canceled)

10. (canceled)

11. (canceled)

12. (canceled)

13. The method according to any one of claim 1, wherein the nanofibers have an aspect ratio of at least about 1000 or 10,000.

14. (canceled)

15. The method according to any one of claim 1, wherein polymer A and polymer B have an interactive solubility parameter of greater than about 0 or 1.

16. (canceled)

17. The method according to any one of claim 1, further treating the composite fiber with a solvent that dissolves the matrix formed by polymer A from the composite material and that does not dissolve the nanofibers formed by polymer B.

18. The method according to any one of claim 1, wherein polymer A and polymer B are present in the blend at a mass ratio of between about 95:5 and about 50:50 or between about 80:20 and about 50:50.

19. (canceled)

20. The method according to any one of claim 1, wherein the blend further comprises of one or more additives, said additives being any one or combination of anti-oxidants, anti-stats, blooming agents, colorants, flame retardants, lubricants, peroxides, stabilizers, and wetting agents.

21. The method according to any one of claim 1, wherein the step of producing the blend is carried out at a processing temperature in a range from about 150° C. to about 400° C.

22. The method according to any one of claim 1, wherein the steps of production of the pellets is controlled to give a mass output of pellets in a range from about 5 kg/h to about 1000 kg/h.

23. The method according to any one of claim 1, wherein the mixture of at least two polymers A and B further comprises of a coupling agent selected to improve a morphology of the nanofibrils.

24. The method according to claim 23, wherein said coupling agent is a grafted/block polymer.

25. The method according to claim 23, wherein said coupling agent is any one or combination of maleic anhydride grafted polypropylene (MA-g-PP), maleic anhydride grafted polyethylene (MA-g-PE) and thermoplastic polyolefin.

26. The method according to any one of claim 1, wherein the mixture of at least two polymers A and B further comprises one or more kinds of chemical agents selected to tune a molecular weight of the polymer B to match the viscosity of polymer A.

27. The method according to claim 26, wherein the additive is selected, and present in the mixture, to give a viscosity ratio of polymer A to polymer B of about 1:1.

28. The method according to any one of claim 1, wherein the step c) of subjecting the composite material to an isotropization/relaxation step is achieved by any one of extrusion, injection and compression/steam molding.

29. A pellet produced by the methods of any one of claim 1, wherein the pellets are for use in injection molding, extrusion, compression molding, injection molding foaming, extrusion foaming, bead foaming, steam chest molding to make product.

30. (canceled)
